(19) United States
(12) Patent Application Publication
(10) Pub. No.: US 2010/0039472 A1
(43) Pub. Date: Feb. 18, 2010

(54) PRINTING HEAD, PRINTING DEVICE, SERIAL DATA GENERATION DEVICE, AND COMPUTER PROGRAM

(75) Inventors: Yuichiro IKEMOTO, Kanagawa (JP); Kazuyasu TAKENAKA, Tokyo (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: Sony Corporation, Tokyo (JP)

(21) Appl. No.: 12/546,895

(22) Filed: Aug. 25, 2009

Related U.S. Application Data
(62) Division of application No. 11/726,088, filed on Mar. 21, 2007.

(30) Foreign Application Priority Data
Mar. 29, 2006 (JP) 2006-092584

(51) Int. Cl. B41J 2/205

(52) U.S. Cl. 347/15

(57) ABSTRACT

A printing head of a liquid discharge type includes a printing head structure, in which head chips, each of which has overlapped nozzle regions formed before and after an effective nozzle region, are disposed such that a front end position of an effective nozzle region of a head chip and a rear end position of an effective nozzle region of another head chip, the head chips being adjacent to each other, are aligned with each other with difference in level.

### CROSS REFERENCES TO RELATED APPLICATIONS

The subject matter of application Ser. No. 10/571,044, is incorporated herein by reference. The present application is a Divisional of U.S. Ser. No. 11/726,088, filed Mar. 21, 2007, which claims priority to Japanese Patent Application JP 2006-092584 filed in the Japanese Patent Office on Mar. 29, 2006, the entire contents of which being incorporated herein by reference.

### BACKGROUND OF THE INVENTION

1. Field of the Invention

The present invention proposed in this specification relates to a printing device of a liquid discharge type that can form one dot by a plurality of droplets (for example, ink droplets).

The invention proposed by the inventor has sides of a printing head, printing device, pattern-table optimization device, and computer program.

2. Background Art

Currently, use of line head structures is investigated aiming to increasing printing speed. The line head structures imply head structures having a number of nozzles arranged in a direction of printing width. In the line head structures, a structure where head length exceeds the total length of printing width is particularly referred to as line head.

Currently, the line head structures are mainly achieved by a method of attaching a plurality of head chips together.

FIG. 1 shows part of a typical line head structure. FIG. 1 is an expanded view of a mounting portion of adjacent, two head chips. As shown in FIG. 1, the two head chips are mounted such that ends of them are situated on a boundary line between the chips. That is, the head chips are disposed such that they are not overlapped with each other at the ends.

JP-A-2005-81621 is exemplified as the related art.

### SUMMARY OF THE INVENTION

When a plurality of head chips are attached together to produce one printing head, a mounting error including tolerance (that is, displacement) may occur.

FIG. 2 shows an example that a gap is formed between head chips by the mounting error. In FIG. 2, the gap is exaggeratingly depicted for convenience of description. When the gap exists between the head chips in this way, a portion where ink droplets are not impacted is sometimes sensed as a white line.

Thus, when a printing head having a gap between head chips is used, correction for increasing printing density (tone) near both sides of the gap in a pseudo manner is typically used. By increasing the printing density, the white line can be corrected such that it is not conspicuous.

FIG. 3A shows an example of dot formation before correction, and FIG. 3B shows an example of dot formation after correction. However, even by using such a correction method, reduction in image quality near the boundary can not be perfectly removed.

In a case of a head chip with overlapped nozzles being not disposed, image quality near the boundary may be reduced because of shift in dot formation timing. The shift in formation timing occurs when a deflected discharge technique is used.

FIG. 4 shows discharge directions of ink droplets by a printing head using the deflected discharge technique. In the case of a nozzle as shown in FIG. 4, the nozzle can separately deposit the ink droplets to three dot positions adjacent to one another in addition to a dot position opposed to the nozzle.

FIG. 5 shows a dot formation method in the boundary portion when the deflected discharge technique is used. Eight blocks arranged in a vertical direction in a head chip correspond to a discharge period of droplets being usable for formation of one dot. A numeral in each block indicates number of a nozzle used for discharging an ink droplet corresponding to each block. That is, FIG. 5 shows a relationship between a discharge nozzle and discharge timing in a case that one dot can be formed by overlapped deposition of a maximum of 8 ink droplets.

As shown in FIG. 5, dots in positions corresponding to nozzle number “1”, “2” and “3” of a “head chip 2” are formed by overlapped deposition with ink droplets discharged from a “head chip 1”.

In a dot corresponding to the nozzle number “1” of the “head chip 2”, 6 blocks in a total of 8 blocks are formed by overlapped deposition with the ink droplets discharged from the “head chip 1”. In a dot corresponding to the nozzle number “2” of the “head chip 2”, 4 blocks in the total of 8 blocks are formed by overlapped deposition with the ink droplets discharged from the “head chip 1”.

In a dot corresponding to the nozzle number “3” of the “head chip 2”, 2 blocks in the total of 8 blocks are formed by overlapped deposition with the ink droplets discharged from the “head chip 1”.

Time difference occurs by time corresponding to offset between head chips (corresponding to several lines), between a time point at which an ink droplet is impacted from the head chip 1 and a time point at which an ink droplet is impacted from the head chip 2. The time difference causes change in dot size even if the number of ink droplets is the same. Moreover, there is a difficulty that when deviation occurs in paper feed, a dot is not formed in a proper position.

In this way, in a printing device of a usual type, image quality tends to be reduced near a boundary between head chips.

According to an embodiment of the invention, there is provided a printing head of a liquid discharge type having a printing head structure in which head chips, each of which has overlapped nozzle regions formed before and after an effective nozzle region, are disposed such that a front end position of an effective nozzle region of ahead chip and a rear end position of an effective nozzle region of another head chip, the head chips being adjacent to each other, are aligned with each other with difference in level.

According to another embodiment of the invention, there is provided, as a device generating serial data to be supplied to the printing head of the liquid discharge type having the printing head structure, a device having a sorting output section outputting multi-level quantization values as the serial data, the values being sorted in an arrangement direction of head chips, and a zero-value insertion section inserting a zero value into the outputted serial data as data for the overlapped nozzle regions.

The number of dots of the zero value to be inserted is desirably controlled to be increased or decreased according to position correction data on a positioning error of each head chip.

By using a configuration, formation of a dot situated in a boundary portion between head chips can be completely achieved in one head chip. Thus, a printing result can be achieved, in which change in dot size or displacement is not found.

When the number of dots of the zero value to be inserted is varied, even if a gap is produced between head chips due to a positioning error of a head chip, a dot can be formed in a proper position.

### BRIEF DESCRIPTION OF THE DRAWINGS

FIG. 1 is a view showing an example of a usual structure of a printing head;

FIG. 2 is a view for explaining displacement of a head chip configuring a printing head;

FIGS. 3A and 3B are views for explaining a usual correction method for displacement of a head chip;

FIG. 4 is a view for explaining a deflected discharge technique of ink droplets;

FIG. 5 is a view for explaining a usual dot formation technique using the deflected discharge technique of ink droplets;

FIGS. 6A and 6B are views showing an example of a structure of a printing head proposed by the inventor;

FIG. 7 is a view for explaining a positional relationship between effective nozzle regions and overlapped nozzle regions;

FIGS. 8A to 8E are views for explaining impact positions of ink droplets;

FIG. 9 is a view for explaining a principle of dot formation in the printing head proposed by the inventor;

FIGS. 10A to 10E are views for explaining another example of impact positions of ink droplets;

FIG. 11 is a view for explaining another principle of dot formation in the printing head proposed by the inventor;

FIG. 12 is a view showing an example of a configuration of a printing device;

FIG. 13 is a view for explaining an example of outputted serial data;

FIG. 14 is a view for explaining an example of a structure of serial data;

FIG. 15 is a view showing an example of a pattern table;

FIGS. 16A to 16C are views for explaining a principle of correction operation when displacement occurs in a head chip;

FIG. 17 is a view showing an example of a procedure of processing in the printing device;

FIG. 18 is a view for explaining a positional relationship between dot patterns in the case that displacement does not occur;

FIGS. 19A to 19C are views for explaining a correction principle when a mounting position of a head chip is displaced right;

FIG. 20 is a view for explaining a positional relationship between dot patterns after data correction when the mounting position of the head chip is displaced right;

FIGS. 21A to 21C are views for explaining a correction principle when the mounting position of the head chip is displaced left;

FIG. 22 is a view for explaining a positional relationship between dot patterns after data correction when the mounting position of the head chip is displaced left;

FIGS. 23A to 23C are views for explaining turbulence in reproducibility of a tone occurring in a boundary portion when a usual printing method is used; and

FIGS. 24A to 24B are views for explaining still another example of impact positions of ink droplets.

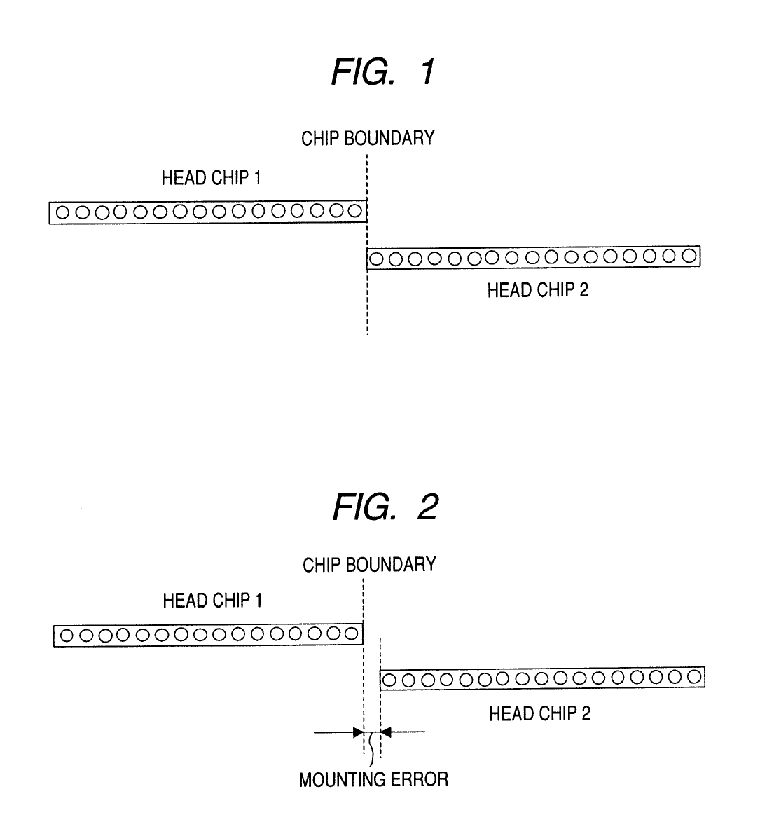

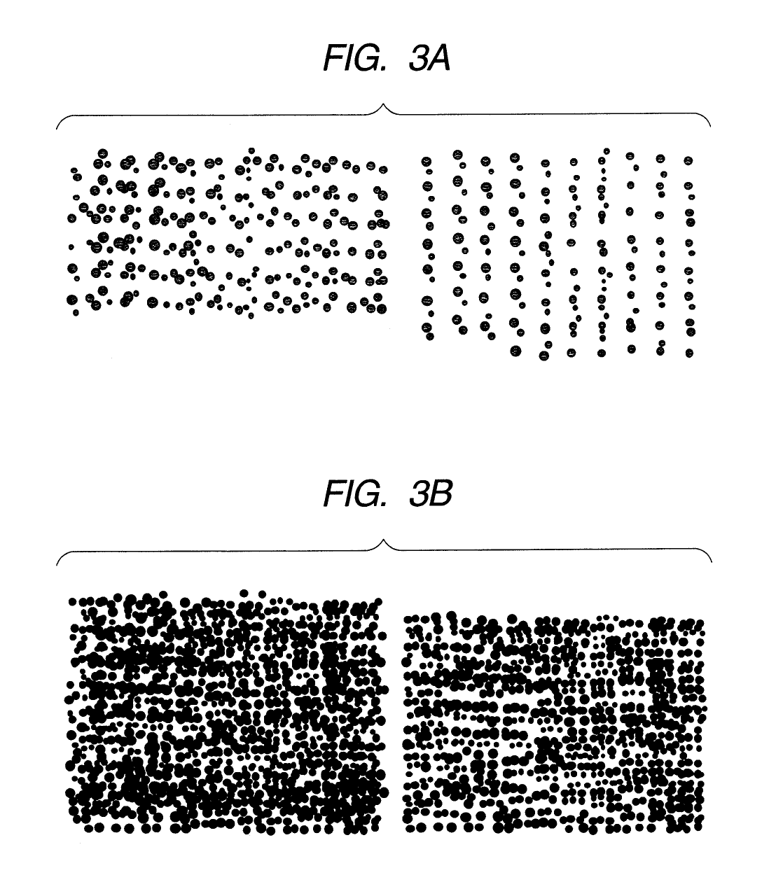

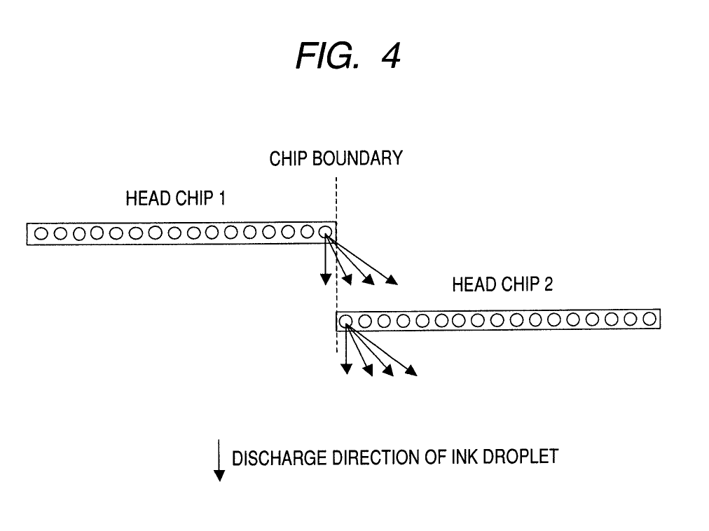

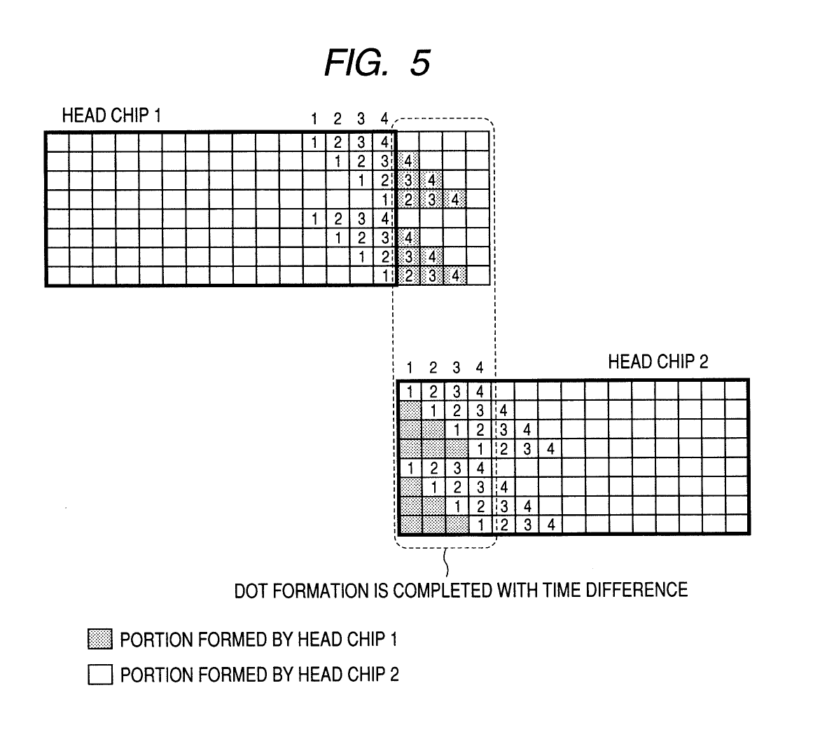

### DESCRIPTION OF PREFERRED EMBODIMENTS

Hereinafter, embodiments of a printing device of a liquid discharge type according to an embodiment of the invention will be described.

Portions being not particularly shown or described in the specification are applied with well-known or known techniques of the relevant technical field.

Moreover, the embodiments described below are merely one embodiment of the invention, and not restrictive.

### (A) Example of Printing Head

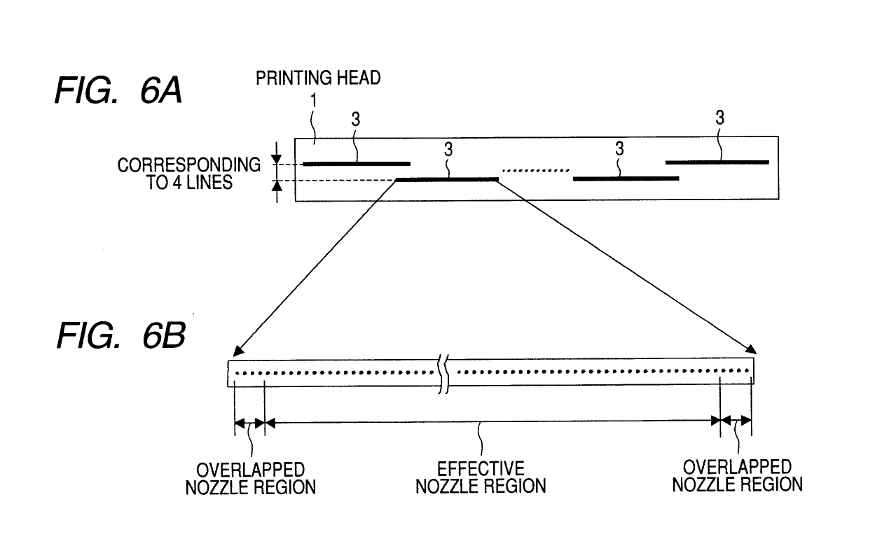

FIGS. 6A and 6B show an example of a structure of a printing head 1 used in the embodiment. The printing head 1 has a printing head structure in which 16 head chips 3, each having overlapped nozzle regions formed in both sides of an effective nozzle region, are disposed in line. In a case of the embodiment, the printing head 1 is assumed to be a line head.

320 nozzles are formed in the effective nozzle region, and 4 nozzles are formed in each of the overlapped nozzle regions, or 8 nozzles in total are formed. Discharge capability is assumed to be not different between the nozzles in the effective nozzle region and the nozzles in the overlapped nozzle regions.

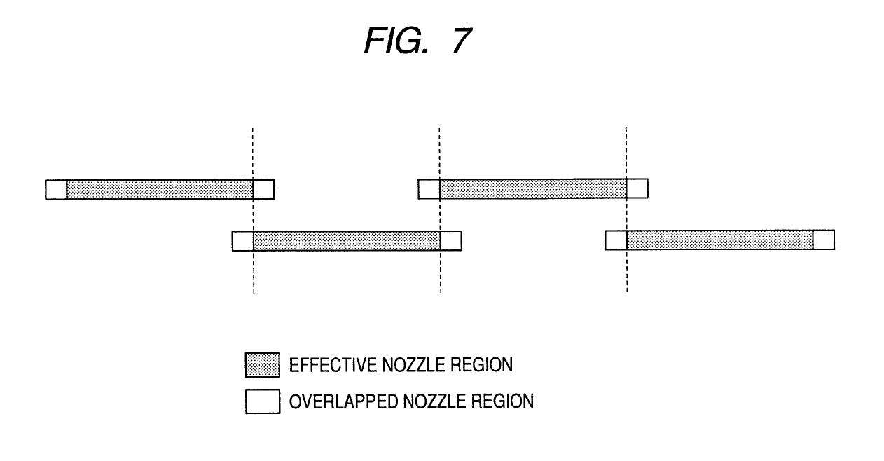

FIG. 7 shows a relationship on a mounting position between the effective nozzle regions and the overlapped nozzle regions. In the figure, halftone portions are the effective nozzle regions, and open portions are the overlapped nozzle regions.

As shown in FIG. 7, a front end position of an effective nozzle region of a head chip and a rear end position of an effective nozzle region of another head chip, the head chips being adjacent to each other, are disposed to be aligned with each other with difference in level. The difference in level in a paper feed direction between adjacent head chips is assumed to be corresponding to 4 lines (4 dots).

Nozzles formed in each region have a drive mechanism being adapted for a dot formation technique by which one dot is formed by a plurality of droplets (ink droplets in the embodiment), in addition, adapted for a deflected discharge technique by which the ink droplets can be discharged to a plurality of dot positions situated in an arrangement direction of nozzles. The drive mechanism corresponds to the “liquid discharge section” in the claims.

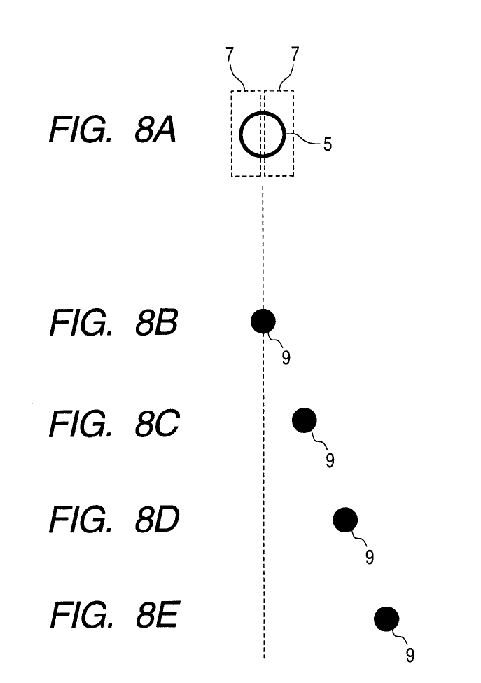

FIGS. 8A to 8E show an example of a structure of the drive mechanism. It is assumed that the drive mechanism in the embodiment can separately deposit ink droplets to 4 dot positions as shown in FIGS. 8A to 8E.

The drive mechanism shown in FIG. 8A includes a nozzle 5 and two heaters 7 disposed at a bottom of the nozzle. In a case of the drive mechanism, balance between currents to be flown into two horizontal heaters 7 is controlled, so that a discharge direction (impact position) of an ink droplet 9 is varied. In a case of this example, each nozzle 5 is assumed to be able to discharge the ink droplet 9 to 4 dot positions as shown in FIGS. 8B to 8E.

A printing head proposed by the inventors uses the deflected discharge technique, and employs a method of discharging an ink droplet from an overlapped nozzle region to a dot in an effective nozzle region in the same head chip, the dot being situated near the boundary.

By using the method, all dots corresponding to effective nozzle regions in each head chip can be formed by nozzles in one head chip.

If formation of dots near the boundary can be completed by only one head chip in this way, change in dot size cause by shift in dot formation timing can be eliminated unlike the usual example. Furthermore, the difficulty of shift in dot formation caused by shift in impact position of an ink droplet can be solved.

Hereinafter, it is described that formation of dots near the boundary can be completed in only one head chip.

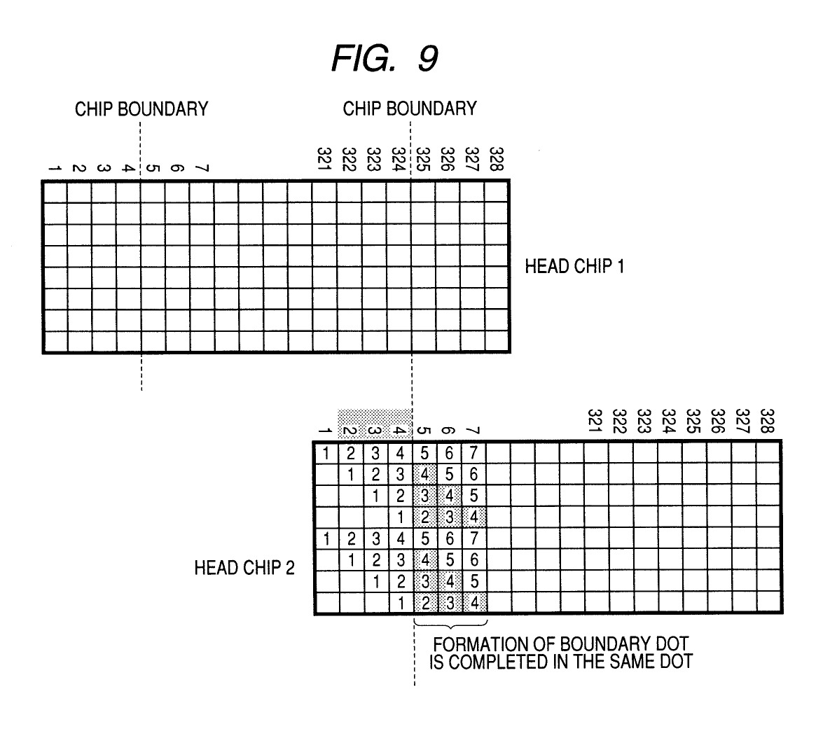

FIG. 9 shows a correspondence relationship between dot positions and nozzles for discharging ink droplets forming respective dots. Again in the case of FIG. 9, 8 blocks arranged in a vertical direction in a head chip correspond to a discharge period of droplets usable for formation of one dot. A numeral in each block indicates number of a nozzle used for discharging an ink droplet corresponding to each block. That is, FIG. 9 shows a relationship between a discharge nozzle and discharge timing in a case that one dot can be formed by overlapped deposition of a maximum of 8 ink droplets.

For example, in a dot corresponding to the nozzle number “5” of the “head chip 2”, 6 blocks in a total of 8 blocks are formed by ink droplets discharged from an overlapped nozzle region of the same “head chip 2”. In a dot corresponding to the nozzle number “6” of the “head chip 2”, 4 blocks in the total of 8 blocks are formed by ink droplets discharged from the overlapped nozzle region of the same “head chip 2”. In a dot corresponding to the nozzle number “7” of the “head chip 2”, 2 blocks in the total of 8 blocks are formed by ink droplets discharged from the overlapped nozzle region of the same “head chip 2”. In FIG. 9, halftone dot portions are formed by ink droplets discharged from the overlapped nozzle region of the “head chip 2.

In the case of the example, nozzles in an overlapped nozzle region provided at a rear end side of the “head chip 1” do not contribute to formation of dots.

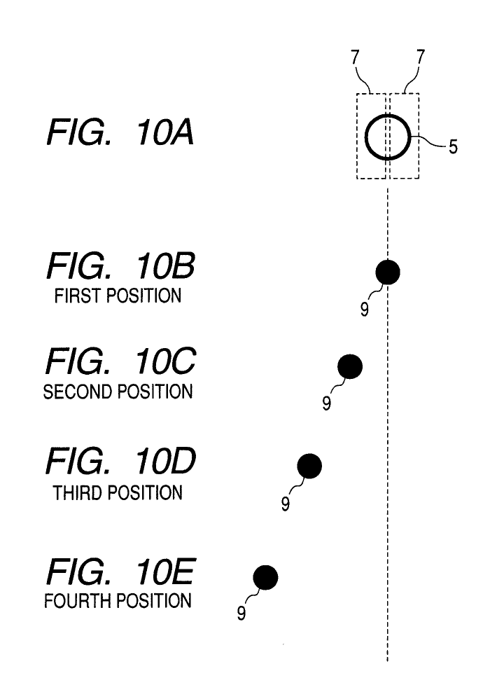

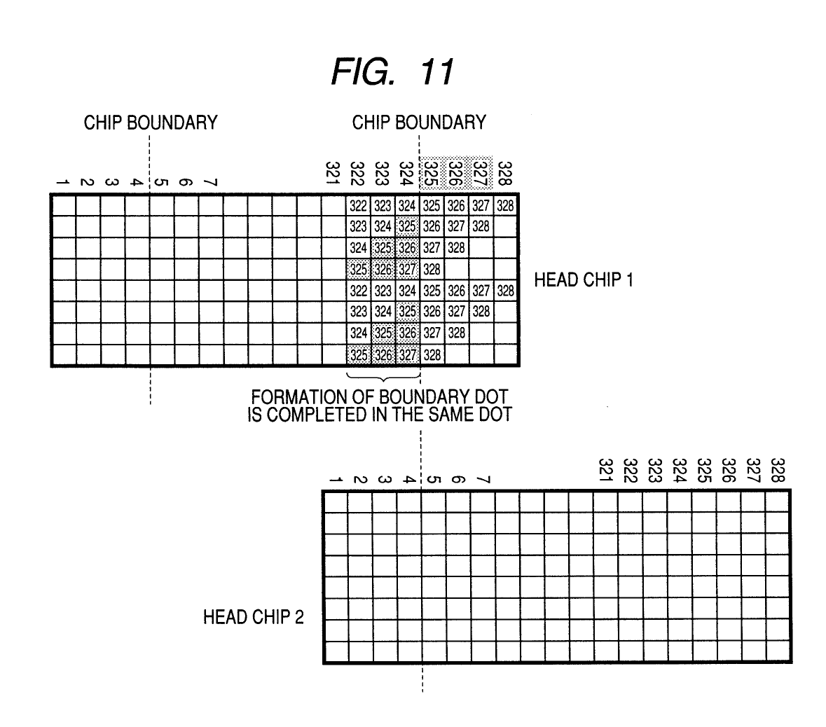

However, when a discharge direction of an ink droplet is opposite to that in FIGS. 8A to 8E, that is, in the case of 4 directions as shown in FIGS. 10A to 10E, a positional relationship between the overlapped nozzle-regions for use in dot formation is reversed. That is, as shown in FIG. 11, the nozzles in the overlapped nozzle region provided at the rear end side of the “head chip 1” contribute to formation of dots, and nozzles in an overlapped nozzle region provided at a front end side of the “head chip 2” do not contribute to formation of dots.

### (B) Example of Printing Device

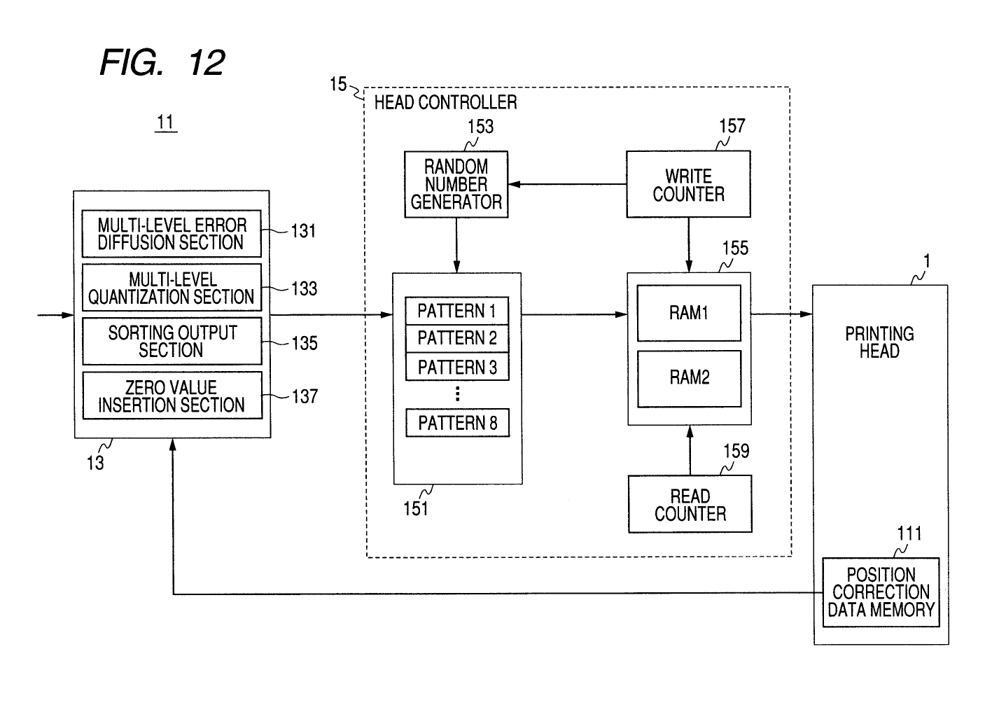

FIG. 12 shows an example of a configuration of a printing device 11 employing this type of printing head.

The printing device 11 includes a digital signal processing section 13, head controller 15, and printing head 1 (FIGS. 6A and 6B).

The digital signal processing section 13 is a processing device that converts inputted image data into a signal mode suitable for printing. In a case of this embodiment, the digital signal processing section 13 includes a multi-level error diffusion section 131, multi-level quantization section 133, sorting output section 135, and zero-value insertion section 137.

The digital signal processing section 13 corresponds to the “serial data generation device” in the claims.

The multi-level error diffusion section 131 is a processing device that performs multi-level error diffusion processing for each color of CMYK signals corresponding to ink colors (cyan, magenta, yellow and black). The multi-level error diffusion section 131 performs processing of converting CMYK signals in 256 tones into 9 tone values corresponding to thresholds.

The multi-level quantization section 133 is a processing device that converts the 9 tone values indicating tone values of respective dots into multi-level quantization values of 0 to 8. The multi-level quantization values correspond to the number of ink droplets forming the respective dots.

The sorting output section 135 sorts the multi-level quantization values to be outputted to the head controller 15 in accordance with arrangement of head chips configuring the printing head 1, and outputs the sorted values as serial data.

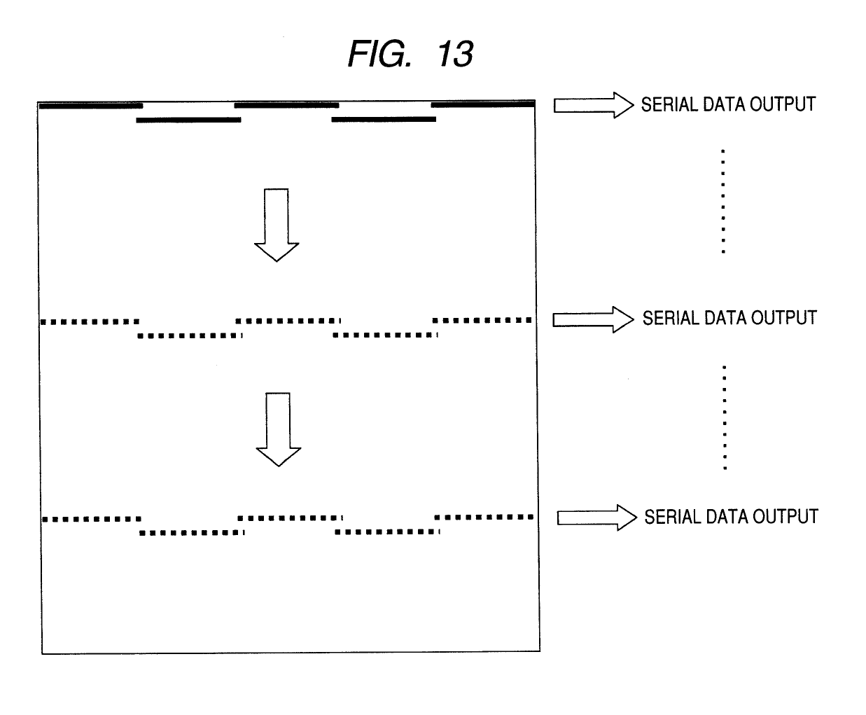

FIG. 13 shows an example of outputted serial data. The serial data are assumed to be outputted right in arrangement order from a dot position at the left in the figure. The serial data correspond to dots in positions corresponding to effective nozzle regions.

The zero-value insertion section 137 is a processing device that inserts zero values as multi-level quantization values corresponding to the overlapped nozzle region.

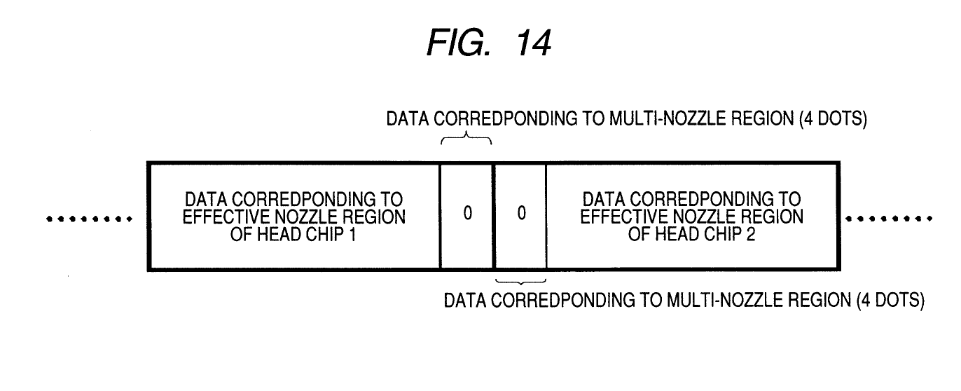

FIG. 14 shows an example of a data structure after inserting the zero values. As shown in FIG. 14, it is seen that zero values of 4 dots are inserted into each of regions before and after the data corresponding to each effective nozzle region.

The head controller 15 is a processing device that converts the multi-level quantization values into dot pattern data. The head controller 15 includes a dot pattern conversion section 151, random number generator 153, line buffer 155, write counter 157, and read counter 159.

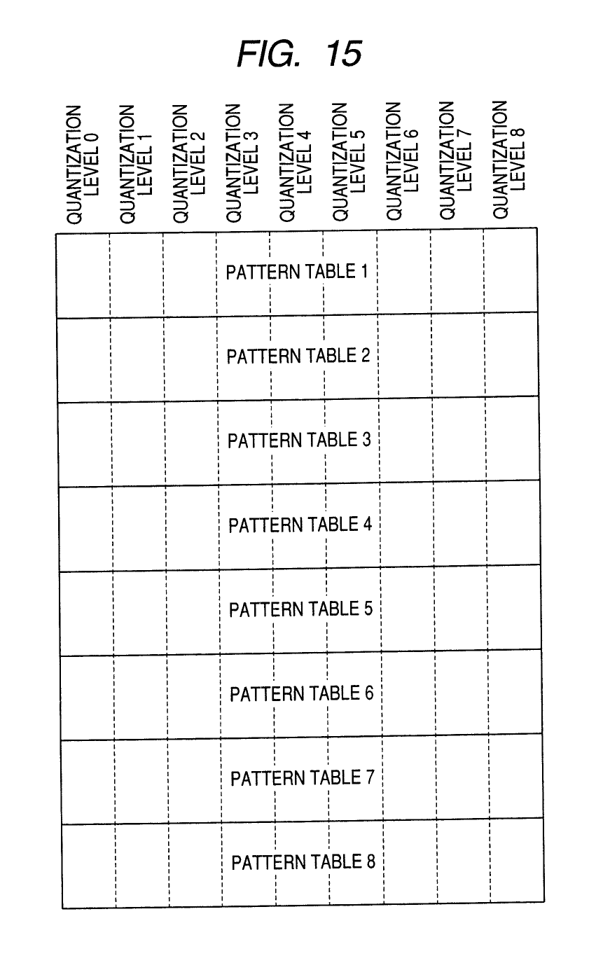

The dot pattern conversion section 151 is a processing device that uses a pattern table selected from 8 pattern tables by the random number generator 153 to convert the multi-level quantization data into a dot pattern. FIG. 15 shows an example of the pattern table.

Here, each pattern table stores 9 multi-level quantization values and dot patterns, which are associated with each other. As previously prepared, 8 pattern tables, pattern tables are used, which all have different correspondence relationships between the multi-level quantization values and the dot patterns.

By using a pattern table randomly selected from the 8 pattern tables, degradation in image quality with regularity of dot patterns is reduced.

The random number generator 153 generates a random number every one dot or several dots according to an address generated by the write counter 157.

The line buffer 155 is a buffer memory having two storage areas for writing and reading. Each storage area herein is secured for storage capacity corresponding to a total value of the total number of nozzles of each head chip (nozzles formed in the effective nozzle region and two overlapped nozzle regions). One of the two storage areas is used for writing of the dot patterns, and the other is used for reading of the dot patterns. Addresses for such reading and writing are provided by the write counter 157 and the read counter 159.

The printing head 1 is a device having a head structure in which 16 head chips are disposed in line for each color. The line head structure corresponding to each color was described with FIGS. 6A and 6B, therefore it is omitted to be described.

In the printing head 1, a position correction data memory 111 is assumed to be mounted. The position correction data memory 111 is a storage area for storing position correction data on a positioning error of each head chip. That is, information on positioning errors of 16 head chips for each color is stored.

For example, information on a fact that a head chip is displaced forward or backward with respect to its original position, and information on the number of dots corresponding to a displacement level are stored as the position correction data.

The position correction data are provided to the zero-value insertion section 137 of the digital signal processing section 13, and used for increasing or decreasing the number of zero values to be inserted.

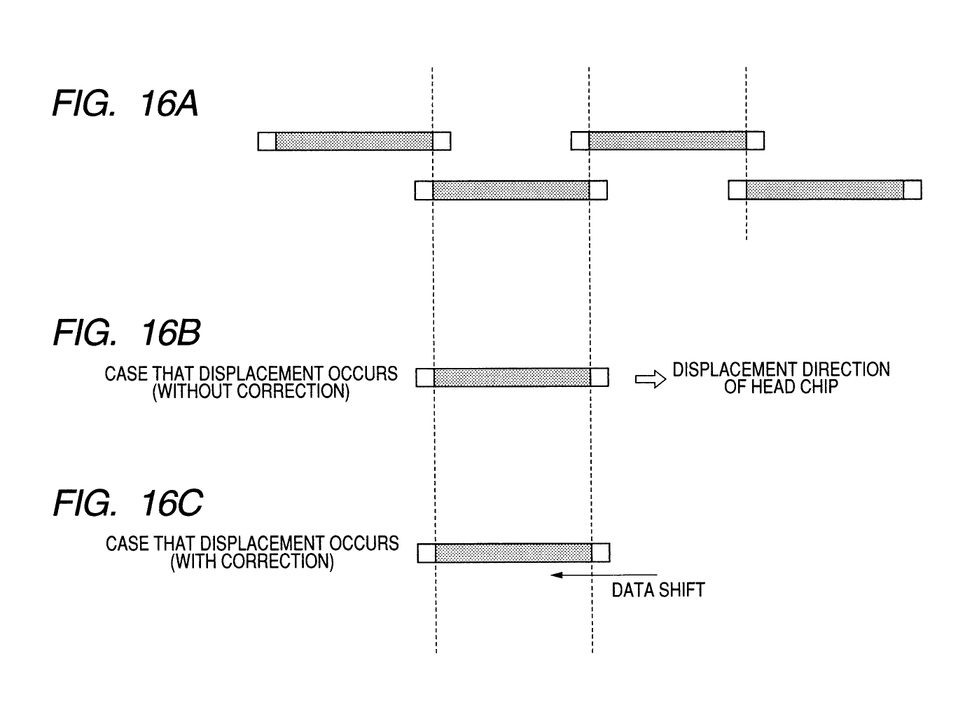

FIGS. 16A to 16C show a correction principle of a dot position based on increased or decreased number of zero values. FIG. 16A shows an arrangement example in the case that head chips are properly positioned.

In the figures, halftone areas indicate allocation regions of data corresponding to the effective nozzle regions, and open areas indicate allocation regions of data (zero values) corresponding to the overlapped nozzle regions. In the case of FIGS. 16A to 16C, zero values are allocated by 4 dots for either of front and rear sides.

FIG. 16B shows a condition that a mounting position of a head chip is displaced backward. FIG. 16B corresponds to the case that an insertion level of the zero values is not corrected at all. In this case, the number of dots in the overlapped nozzle region is secured for 4 dots. As a result, a dot formation start position in positions of dots formed by the head chip is shifted by a level of the displacement, leading to formation of a white line.

FIG. 16C also corresponds to the condition that the mounting position of the head chip is displaced backward. However, in this case, the number of dots of zero values to be inserted into a front side of a head chip is decreased by the displacement level, and all the data corresponding to the effective nozzle region is shifted forward. The number of dots of zero values to be inserted into a rear side of the head chip is conversely increased.

By such correction processing, the halftone portion indicating the allocation region of data corresponding to the effective nozzle region is allowed to correspond to the same position as in the case that the head chips are properly positioned.

As a result, dots are securely formed with original tones in proper positions between two head chips irrespective of a physical positioning error of the head chip.

In the case of this embodiment, positions of dots being formable by one nozzle are corresponding to 4 dots. Therefore, in the case of this embodiment, when the positioning error corresponds to 1 dot, dots can be formed in proper positions with correct tones without affecting data of another head chip.

### (C) Printing Operation

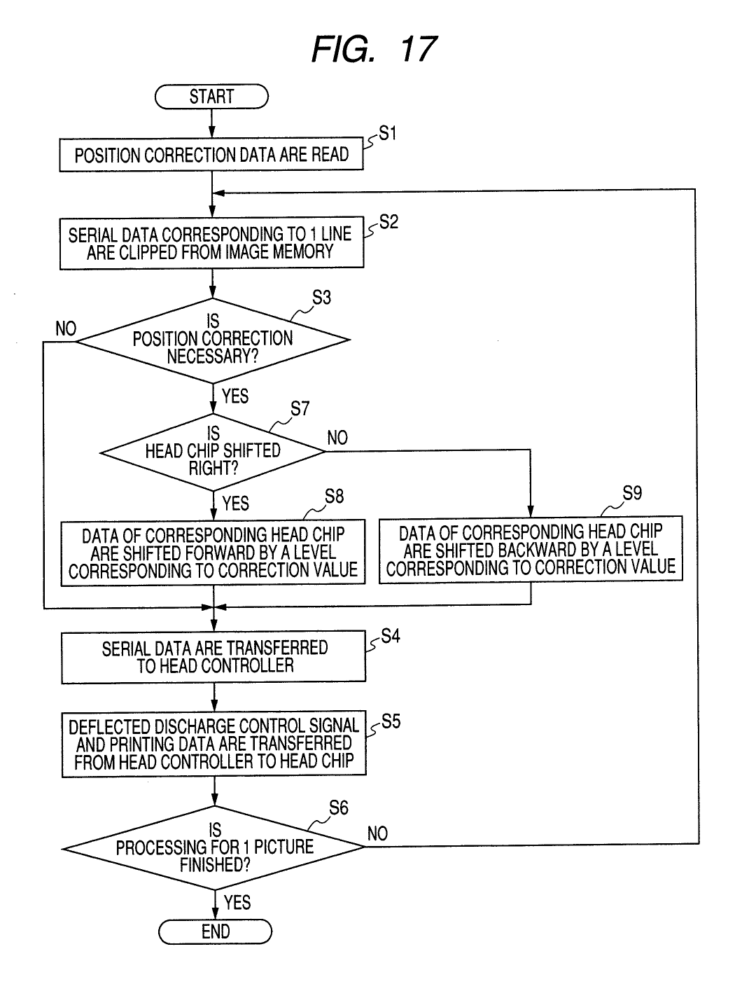

FIG. 17 shows an example of a procedure of processing performed in the printing device 11.

First, prior to performing printing, position correction data are read from the printing head 1 (S1) The position correction data are provided to the zero-value insertion section 137 of the digital signal processing section 13.

Next, the sorting output section 135 accesses an image memory of the digital signal processing section 13 to read a multi-value quantization values corresponding to 1 line in order of arrangement of the head chips (S2). Serial data corresponding to the 1 line (FIG. 13) are provided to the zero-value insertion section 137.

In this stage, the zero-value insertion section 137 determines whether position correction is necessary or not based on information of the position correction data (S3).

When the head chips are properly mounted (that is, the position correction data are zero for all the head chips), the zero-value insertion section 137 obtains a negative result in the determination process of S3.

In this case, the zero-value insertion section 137 transfers serial data (FIG. 14), in which zero values are inserted for 4 dots each, or 8 dots in total before and after 320 dots corresponding to the effective nozzle region, to the head controller 15 (S4).

Multi-level quantization values of the serial data are converted into a dot pattern by the dot pattern conversion section 151, then the dot pattern is outputted to the printing head 1 as printing data through the line buffer 155 (S5).

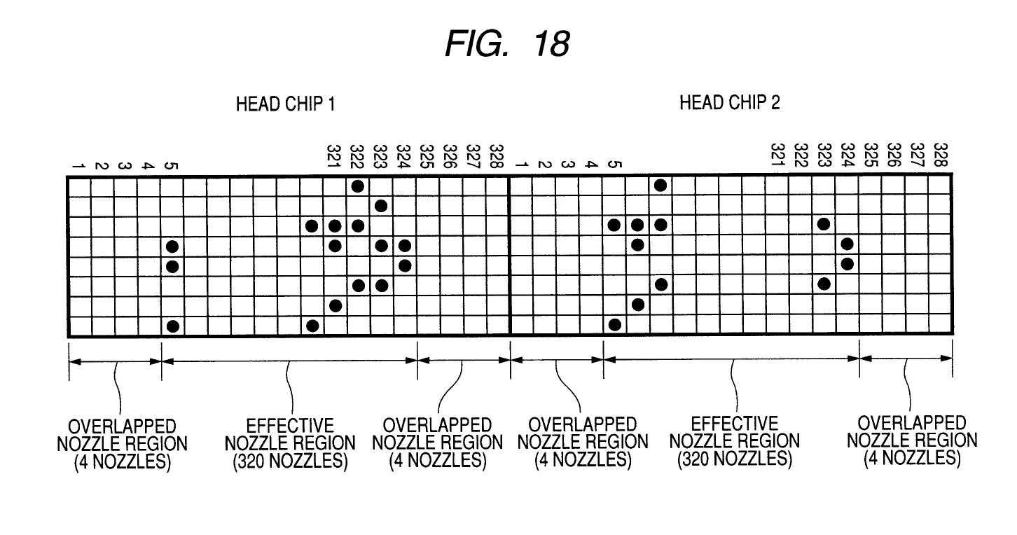

FIG. 18 shows an example of dot patterns outputted when a head chip is properly mounted. While dot patterns in a central portion of the effective nozzle region are omitted to be shown in FIG. 18, it is known that dot patterns do not exist in each of 4-dot regions corresponding to the overlapped nozzle region before and after the effective nozzle region. As previously described, 8 blocks arranged in a vertical direction correspond to 1 dot, and blocks having black circles indicate discharge timing of ink droplets. Each of the 8 blocks is allocated with a discharge direction of an ink droplet. Information providing the discharge direction of the ink droplet is outputted to the printing head 1 as a deflected discharge control signal.

Then, the zero-value insertion section 137 determines whether processing for 1 picture is fully finished or not (S6).

Here, the zero-value insertion section 137 repeats the processes from S2 to S5 while the negative result is obtained.

On the other hand, when a positive result is obtained, determination operation for 1 page is finished.

Next, a case that the positive result is obtained in the process S3 is described. This means that displacement occurs in head chips at one or several places. For example, it means that the position correction data are not zero.

The zero-value insertion section 137 performs determination operation of confirming a displacement direction of a head chip (S7). In this example, the zero-value insertion section 137 determines whether a displacement direction of the head chip is right or not.

While the determination operation is represented to be performed only one time for 1 line for simplifying description in FIG. 17, the operation is actually performed for each head chip.

When the displacement direction of the head chip is determined to be right (back) (when the positive result is obtained in the process S7), the zero-value insertion section 137 generates serial data in which data of a corresponding head chip is shifted forward by a correction value (S8). Specifically, processing is performed, in which the number of zero values to be inserted before data for 320 dots corresponding to the effective nozzle region is decreased by the correction value, and the number of zero values to be inserted after the data is increased by the correction value.

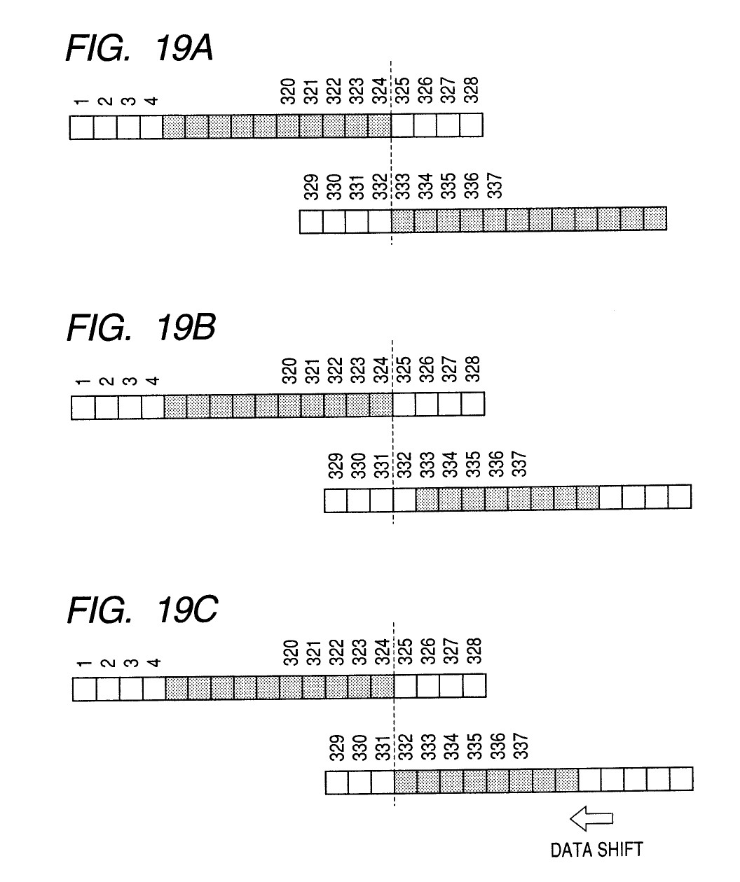

FIGS. 19A to 19C show an example of dot patterns outputted when a mounting position of a head chip is displaced right. FIG. 19A shows an example of effective nozzle region data being arranged when a head chip is properly positioned.

FIG. 19B shows an example of arranged data without performing shift processing of the effective nozzle region data when mounting position of the head chip is displaced right by 1 dot. Zero values for 4 dots are inserted each before and after the effective nozzle region data. As a result, a dot formation start position is displaced right by 1 dot, leading to formation of a white line.

While FIG. 19C also shows an example of the case that mounting position of the head chip is displaced right by 1 dot, it is an arrangement example of data in which the effective nozzle region data is subjected to the shift processing. In the case of the example, since a displacement level is 1 dot, zero values for 3 dots are inserted before the effective nozzle region data, and zero values for 5 dots are inserted after it. As a result, the dot formation start position is the same as in FIG. 19A. That is, the dot formation start position is the same as that in the case that displacement does not occur, despite occurrence of displacement of the head chip.

Then, processes from S4 to S6 are performed in turn, and the same processes are repeatedly performed until printing of 1 page is completed.

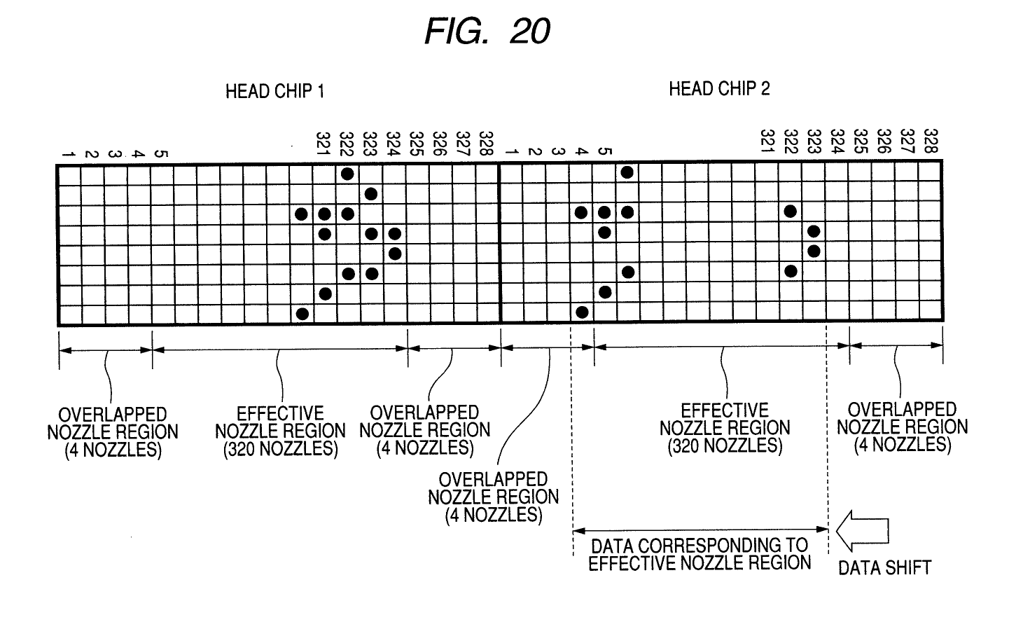

FIG. 20 shows an output example of dot patterns produced in this case. As shown in FIG. 20, dot patterns for 320 dots corresponding to the effective nozzle region is stored in a region of nozzle number “4” to “323” of the “head chip 2”.

As a result, a printing result is ensured, in which a dot gap is not formed between the head chips. Moreover, in the case of this example, since 3 nozzles involved in discharge of a dot pattern corresponding to the nozzle number “4” is secured in a front side of the “head chip 2”, ink droplets necessary for dot formation can be discharged in proper quantities. That is, correct tone expression can be achieved in addition to eliminating formation of the white line.

On the other hand, when the displacement direction of the head chip is determined to be left (front) (when the negative result is obtained in the process S7), the zero-value insertion section 137 generates serial data in which data of a corresponding head chip is shifted backward by a correction value (S9). Specifically, processing is performed, in which the number of zero values to be inserted before the data for 320 dots corresponding to the effective nozzle region is increased by the correction value, and the number of zero values to be inserted after the data is decreased by the correction value.

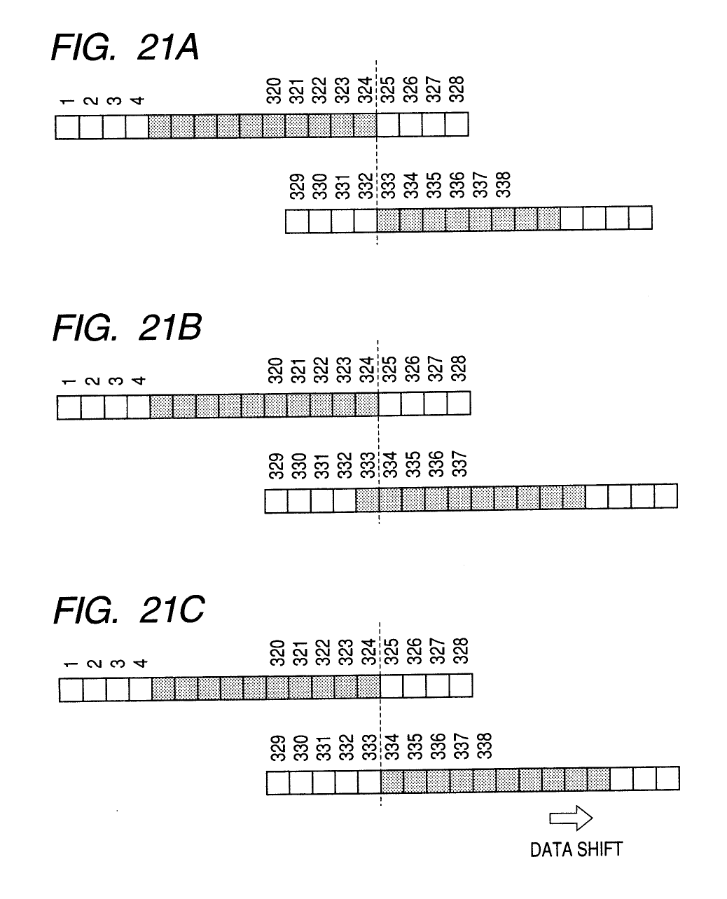

FIGS. 21A to 21C show an example of dot patterns outputted when a mounting position of a head chip is displaced left. FIG. 21A shows an example of effective nozzle region data being arranged when a head chip is properly positioned.

FIG. 21B shows an example of arranged data without performing the shift processing of the effective nozzle region data when mounting position of the head chip is displaced left by 1 dot. Zero values for 4 dots are inserted each before and after the effective nozzle region data. As a result, a dot formation start position of the “head chip 2” is overlapped with a dot formation end position of the “head chip 1”, leading to formation of black solid or an overlapped image.

While FIG. 21C also shows an example of the case that mounting position of the head chip is displaced left by 1 dot, it is an arrangement example of data in which the effective nozzle region data is subjected to the shift processing. In the case of the example, since a displacement level is 1 dot, zero values for 5 dots are inserted before the effective nozzle region data, and zero values for 3 dots are inserted after it. As a result, the dot formation start position is the same as in FIG. 21A. That is, the dot formation start position is the same as that in the case that displacement does not occur, despite occurrence of displacement of the head chip.

Then, processes from S4 to S6 are performed in turn, and the same processes are repeatedly performed until printing of 1 page is completed.

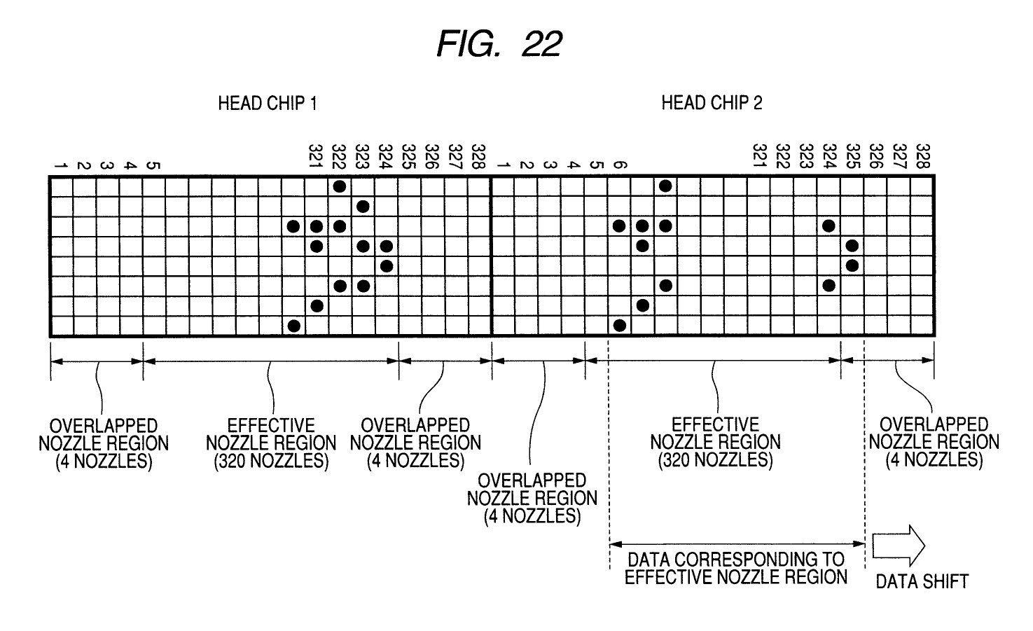

FIG. 22 shows an output example of dot patterns produced in this case. As shown in FIG. 22, dot patterns for 320 dots corresponding to the effective nozzle region is stored in a region of nozzle number “6” to “325” of the “head chip 2”.

As a result, a printing result is ensured, in which the dot gap is not formed between the head chips. Moreover, in the case of this example, since 3 nozzles involved in discharge of a dot pattern corresponding to the nozzle number “6” is secured in a front side of the “head chip 2”, ink droplets necessary for dot formation can be discharged in proper quantities. That is, correct tone expression can be achieved in addition to eliminating the black solid or overlapped image.

### (D) Advantages

By using the printing device 11, occurrence of a situation that a boundary between head chips is sensed as the white line or black solid in an image can be securely reduced. In particular, when the dot number to be secured for the overlapped nozzle region and a deflection level in deflected discharge are optimized, and a printing head having displacement in such an optimized range is used as a normal head, an excellent image can be ensured.

Moreover, by using the head chip structure and the correction processing for displacement of the head chip, fraction defective of the printing head can be reduced. As a result, reduction in manufacturing cost can be achieved.

Moreover, in the case of the head chip structure, since all dots can be formed by ink droplets discharged from one head chip, including dots situated in the boundary between head chips, when the dot pattern conversion section 151 refers to different pattern tables between “head chip 1” and “head chip 2” (even if they are different at least near the boundary), a situation that while the section 151 refers to the same multi-level quantization values for the same dot, it converts the values to a different dot pattern can be eliminated.

Therefore, when a dot situated near the boundary is formed by ink droplets discharged from different head chips, possibility that the number of ink droplets configuring the dot is changed to be increased or decreased with respect to an original value can be eliminated.

Again in this meaning, reproducibility of image quality near the boundary can be improved compared with the related art.

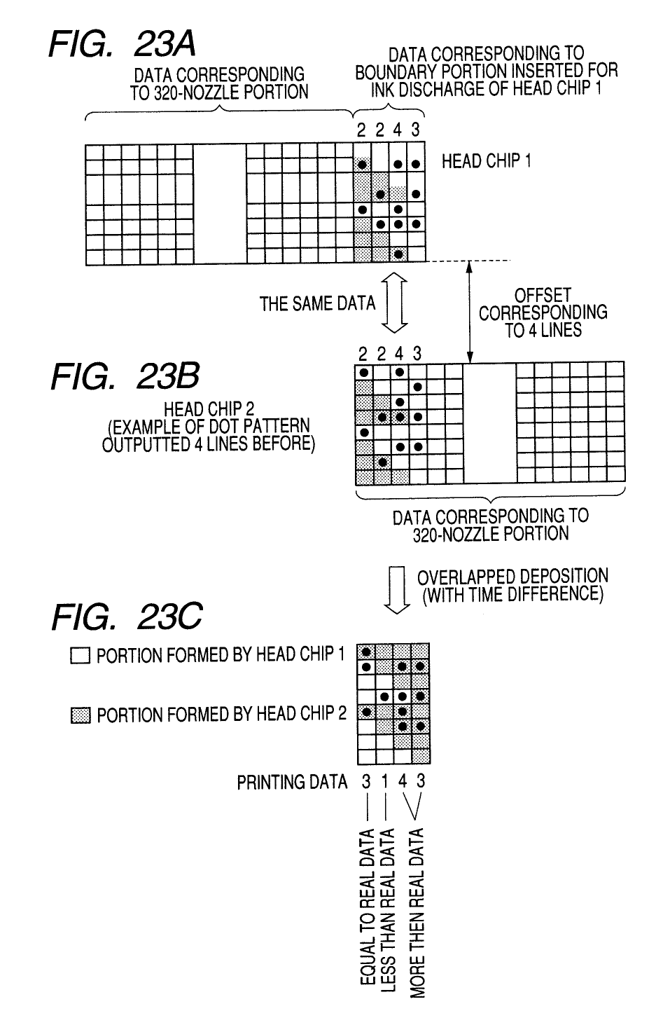

For reference, FIGS. 23A to 23C show a principle of occurrence of turbulence in tone near the boundary in the case of a usual method. It is known that even if the same multi-level quantization values are converted to a dot pattern, when a pattern table to be seen is different, the number of ink droplets is not correctly reproduced.

### (E) Another Embodiment

(a) In the above embodiment, a case that the printing head was adapted for 4-color ink was described. However, the printing head can be adapted for ink of any number of colors including 1 color.

(b) In the above embodiment, a case that one nozzle separately deposited ink droplets in only one direction of right and left directions by using the deflected discharge technique was described.

It is obvious that this is an example, and the nozzle may separately deposit the ink droplets to 2 or 3 dot positions, or at least 5 dot positions.

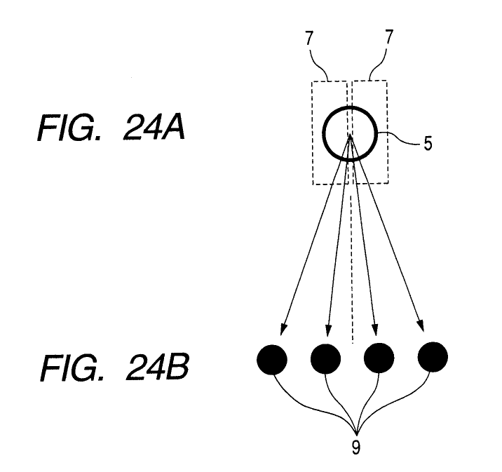

Furthermore, regarding the discharge direction of ink droplets, the printing head can be used for the case that the droplets are separately deposited right and left with respect to a nozzle, as shown in FIGS. 24A to 24B.

(c) In the above embodiment, the printing head in which head chips were disposed such that they traversed full printing width, so-called line head was described.

However, the printing head having the structure where a plurality of head chips are disposed in line can be used for a printing head in which an arrangement range of the head chips is limited to part of printing width, so-called serial head.

(d) The above embodiment can be applied to a printing device irrespective of whether it is for business use or for personal use. For example, it can be applied to a printer for office use, printer for medical use, photo printer, copying machine, facsimile machine, versatile printer, video printer and the like.

The printing device may be equipped with a device having a function other than a printing function, for example, display device or scanner.

Moreover, the printing device may be equipped with a large-capacity storage device for storing image data. As the large-capacity storage device, for example, a hard disk drive unit, a semiconductor memory, and an optical storage medium are used.

(e) In the above techniques, regarding a function of shifting multi-level quantization values corresponding to the effective nozzle region depending on a displacement level of a head chip, an equivalent function can be achieved by hardware or software.

Furthermore, all the processing functions may be achieved by hardware or software, in addition, part of them may be achieved by hardware or software. That is, a configuration where hardware and software are combined may be used.

(f) Various modifications can be considered for the embodiments within a scope of the gist of the invention. Furthermore, various modifications and applications created based on the description of the specification can be considered.

It should be understood by those skilled in the art that various modifications, combinations, sub-combinations and alterations may occur depending on design requirements and other factors insofar as they are within the scope of the appended claims or the equivalents thereof.

1.-2. (canceled)

3. A printing device, comprising:
a printing head of a liquid discharge type having a printing head structure in which head chips, each of which has overlapped nozzle regions formed before and after an effective nozzle region, are disposed such that a front end position of an effective nozzle region of a head chip and a rear end position of an effective nozzle region of another head chip, the head chips being adjacent to each other, are aligned with each other with difference in level,
a multi-level quantization section converting tone data corresponding to the effective nozzle region to multi-level quantization values,
a sorting output section outputting the multi-level quantization values as serial data, the values being sorted in an arrangement direction of the head chips,
a zero-value insertion section inserting a zero value into the outputted serial data as data for the overlapped nozzle regions, and
a line buffer that concurrently performs writing of serial data after zero-value insertion, and reading of the serial data for the printing head.

4. The printing device according to claim 3,
wherein the zero-value insertion section increases or decreases the number of insertion dots of the zero values in proportion to physical dot number in the overlapped nozzle region according to position correction data on a positioning error of each head chip.

5. A serial data generation device,
wherein when a printing head of a liquid discharge type has a printing head structure in which head chips, each of which has overlapped nozzle regions formed before and after an effective nozzle region, are disposed such that a front end position of an effective nozzle region of a head chip and a rear end position of an effective nozzle region of another head chip, the head chips being adjacent to each other, are aligned with each other with difference in level,
the serial data generation device includes,
a sorting output section for outputting the multi-level quantization values as serial data, the values being sorted in an arrangement direction of the head chips, and
a zero-value insertion section inserting a zero value into the outputted serial data as data for the overlapped nozzle regions.

6. The serial data generation device according to claim 5,
wherein the zero-value insertion section increases or decreases the number of dots of the zero values to be inserted for the overlapped nozzle regions according to position correction data on a positioning error of each head chip.

7. A computer program controlling generation operation of serial data in a printing device being equipped with a printing head of a liquid discharge type having a printing head structure in which head chips, each of which has overlapped nozzle regions formed before and after an effective nozzle region, are disposed such that a front end position of an effective nozzle region of a head chip and a rear end position of an effective nozzle region of another head chip, the head chips being adjacent to each other, are aligned with each other with difference in level,
wherein the computer program allows a computer to execute processing of controlling to increase or decrease the number of dots of the zero values for the overlapped nozzle regions to be inserted into multi-level quantization values outputted as serial data in an arrangement direction of the head chips, according to position correction data on a positioning error of each head chip.
